(19) United States
(12) Patent Application Publication
(10) Pub. No.: US 2004/0054864 A1
(43) Pub. Date: Mar. 18, 2004

(54) Memory controller

(76) Inventor: Neil Andrew Jameson, Haverhill (GB)

Correspondence Address: NIXON & VANDERHYE P.C., 8th Floor, 1100 North Glebe Road, Arlington, VA, 22201, US

(21) Appl. No.: 10/242,669

(22) Filed: Sep. 13, 2002

(51) Int. Cl. G06F 12/00

(52) U.S. Cl. 711/167; 711/169

(57) ABSTRACT

The present invention provides a memory controller and memory controlling method for controlling transfers to or from a memory device of a type where each transfer comprises a sequence of distinct phases and the actual sequence of distinct phases is dependent on the type of transfer. In a particularly preferred embodiment, the memory device is a NAND flash memory device. The memory controller comprises a memory device interface operable to couple the memory controller with the memory device, a number of programmable timing registers programmable to store timing information appropriate for the memory device whose transfers are to be controlled by the memory controller, and a number of programmable control registers which, prior to each transfer, are programmable to define the actual sequence of distinct phases to be performed for that transfer and one or more control values for that transfer. A sequence generator is then used to generate each transfer dependent on the contents of the number of programmable timing registers and the number of programmable control registers, and to output each transfer via the memory device interface. It has been found that such an approach provides a particularly efficient interface mechanism for controlling transfers to or from such memory devices.

### BACKGROUND OF THE INVENTION

1. Field of the Invention

The present invention relates to a memory controller and memory controlling method, and more particularly to a memory controller and memory controlling method for controlling transfers to or from a memory device of a type where transfers comprise distinct phases and the actual sequence of the distinct phases is dependent on the type of transfer.

2. Description of the Prior Art

It is known to provide memory controllers for controlling transfers to or from standard memory devices such as Static Random Access Memory (SRAM) and Synchronous Dynamic Random Access Memory (SDRAM) devices. Such memory devices use separate address and data buses and the various transfer types have a fairly fixed format, for example a read transfer will typically involve issuing an address on the address bus, followed by one or more data values on the data bus, whilst a write transfer will typically involve issuing an address on the address bus, and receiving over the data bus one or more data values output by the memory device. One or more control signals will typically be issued to the memory device to indicate whether the transfer is a read or a write transfer.

However, with the advent of memory devices of the type where transfers comprise distinct phases, and the actual sequence of the distinct phases is dependent on the type of transfer, the job of constructing each transfer sequence becomes significantly more complex, and a problem exists in providing an efficient memory controller for generating and controlling transfers to or from such memory devices. An example of such a memory device is a NAND flash memory device, such a memory device using a combined address and data bus. Each transfer relating to a NAND flash memory device requires a command phase, in which a command value is supplied to the NAND flash memory device to define the type of transfer to be performed, followed by a number of optional distinct phases, for example one or more address phases and one or more data phases. In addition to the actual sequence of distinct phases being dependent on the type of transfer, it is also common in the NAND flash memory device field for the actual sequence of distinct phases for a particular transfer type to vary dependent on the actual NAND flash memory device being used.

One suggested approach for accessing NAND flash memory devices is described in an application note entitled “Simple System Interface for UltraNAND Flash”, Publication No. 22363, and available from Advanced Micro Device's (AMD's) website. This describes the use of an SRAM interface to which is added some simple external glue logic in the form of a Programmable Logic Device (PLD) controlled using the standard SRAM interface. However, with such an approach, the software required to generate the required sequences for each transfer type, with correct timing, will be complex. Further, multiple memory accesses would need to be performed to generate the NAND flash transfer sequence, requiring extended use of the system bus connecting the system processor with the SRAM interface.

As an alternative to the minimalist hardware approach suggested in the above AMD paper, it will be appreciated that a complete hardware implementation with a minimum amount of software would be possible, but the variations in transfer sequences between NAND flash memory devices would require many combinations of transfers and commands to be built into the hardware for all currently available devices to be supported, thereby significantly increasing the gate count of the interface. Furthermore, supporting future devices with minor differences in the transfer sequences or command values would require costly updates to the hardware. Thus, such an approach would be costly, and would not be very future proof if devices with different command values or transfer sequences become available.

Accordingly, it would be desirable to provide a more efficient memory controller for controlling transfers to or from a memory device of a type where transfers comprise distinct phases and the actual sequence of the distinct phases is dependent on the type of transfer, such as is the case, for example, for NAND flash memory devices.

### SUMMARY OF THE INVENTION

Viewed from a first aspect, the present invention provides a memory controller for controlling transfers to or from a memory device of a type where each transfer comprises a sequence of distinct phases and the actual sequence of distinct phases is dependent on the type of transfer, the memory controller comprising: a memory device interface operable to couple the memory controller with the memory device; a number of programmable timing registers programmable to store timing information appropriate for the memory device whose transfers are to be controlled by the memory controller; a number of programmable control registers which, prior to each transfer, are programmable to define the actual sequence of distinct phases to be performed for that transfer and one or more control values for that transfer; and a sequence generator operable to generate each transfer dependent on the contents of the number of programmable timing registers and the number of programmable control registers, and to output each transfer via the memory device interface.

In accordance with the present invention the memory controller is provided with a number of programmable timing registers, a number of programmable control registers, and a sequence generator operable to generate each transfer dependent on the contents of those registers. The timing registers are programmable to store timing information appropriate for the memory device whose transfers are to be controlled by the memory controller. Hence, the memory controller is generic in that it can be used with memory devices having different timing characteristics, with the relevant timing information being programmed into the programmable timing registers dependent on the memory device whose transfers are to be controlled by the memory controller.

Further, the programmable control registers are arranged to be programmed for each transfer so as to define the actual sequence of the distinct phases to be performed for that transfer and one or more control values for that transfer. This approach enables the number of control registers to be limited, since only sufficient control registers are required to store the necessary information for an individual transfer.

It will be appreciated that the control registers can be programmed in a variety of ways. However, as an example, the control registers may be programmed by suitable software executing on a processor coupled to the memory controller via a system bus. Since the control registers are programmed prior to each transfer, the system bus and processor can be freed up for other uses whilst the sequence generator then generates the actual transfer defined by the contents of those programmable control registers, thereby enabling more efficient use of the system bus and processor.

Accordingly, it can be seen that the present invention strikes a balance between the hardware and the software used in the interface, allowing for improved efficiency over a basic hardware interface with complex software implementation, and improved future memory device compatibility and reduced gate count over a full hardware with minimum software implementation. The present invention uses enough hardware to ensure efficient use of the system bus and the bus coupling the memory device with the memory controller (also referred to herein as the external bus) by allowing the correct sequence of distinct phases for each transfer to be programmed by software without needing knowledge of the detailed control signal operation, and allows for support of new transfer sequences, such as may be specified by new memory devices, by using the software to set up the exact sequence and control values used in the transfer to be performed. Therefore, support of new memory devices would typically not require hardware changes, but rather would only require relatively cheap software updates.

It will be appreciated that the memory device may be coupled with the memory controller in a variety of ways. However, in preferred embodiments, the memory device is arranged to receive the distinct phases of each transfer over a common bus coupled to the memory device interface.

It will be appreciated that the present invention could be utilised to control transfers to or from any memory device of the type where transfers comprise distinct phases and the actual sequence of distinct phases is dependent on the type of transfer, or indeed on the actual memory device itself. However, in preferred embodiments the memory device is a NAND flash memory device.

It will be appreciated that the distinct phases used within the sequences defined for the individual transfer types may take a variety of forms. However, in preferred embodiments, a first distinct phase is a command phase during which information identifying the type of transfer is provided to the memory device. In such embodiments the one or more control values programmable into the number of programmable control registers preferably comprise one or more command values associated with the command phase of the transfer. Hence, in such embodiments, the control registers define not only where the command phase or command phases appear within the sequence, but also define the command values to be output during the command phase(s).

In preferred embodiments, a second distinct phase is an optional address phase during which an address associated with the transfer is provided. The address phase is optional since in preferred embodiments certain types of transfer are defined which do not require any addresses to be generated. In situations where an optional address phase is specified, the one or more control values programmable into the control registers preferably comprise any addresses associated with the transfer. Hence, in preferred embodiments, the control values may comprise both one or more command values and any addresses associated with the transfer. With regard to the address generation for the transfer, it can be seen that the control registers define not only where in the sequence the address phase or address phases appear, but also the values of the addresses to be output in those address phases.

In preferred embodiments, a third distinct phase is an optional data phase in which a data value is written to or read from the memory device. As with the address phase, the data phase is optional, since in preferred embodiments there are types of transfer that can be specified which do not require reading or writing of data.

It will be appreciated that there are a number of ways in which the programmable timing registers and the programmable control registers can be programmed. However, in preferred embodiments, the memory controller further comprises a system bus interface operable to couple the memory controller with a system bus over which may be provided control signals used to program the number of programmable timing registers and the number of programmable control registers.

In such embodiments, a processor is preferably coupled to the system bus and is operable to execute software in order to generate the control signals. It will be appreciated by those skilled in the art that the software will be written dependent on the actual memory device being controlled by the memory controller.

It will also be appreciated that the sequence generator may take a variety of forms. However, in preferred embodiments the sequence generator comprises a state machine operable to generate for each transfer the corresponding sequence of distinct phases. It has been found that such an approach provides a particularly efficient implementation for the sequence generator.

The memory controller of the present invention may be used to control transfers to or from a single memory device. However, in alternative embodiments, the memory controller is operable to control transfers to or from a plurality of said memory devices of the type where each transfer comprises a sequence of distinct phases and the actual sequence of distinct phases is dependent on the type of transfer. In such embodiments, it would be possible to allow simultaneous control of multiple such memory devices by replication of the relevant hardware of the memory controller. However, it will typically be important to avoid any unnecessary increase in the amount of hardware, and in such embodiments the hardware would not be replicated and the memory controller would typically be able to only control a single one of the plurality of memory devices at any particular point in time.

The memory controller may be arranged solely to control transfers to or from a memory device, or multiple memory devices, of the type where each transfer comprises a sequence of distinct phases and the actual sequence of distinct phases is dependent on the type of transfer. In such embodiments, it will be appreciated that such a memory controller could be used alongside other memory controllers provided for different types of memory devices, with an external databus multiplexer being used to couple the various controllers to the external data bus. As an example, such a memory controller may be used alongside separate or combined SRAM/SDRAM controllers. However, in alternative embodiments, the memory controller further comprises control logic operable to control a further memory device of a different type, the further memory device being arranged to communicate with the memory controller via an address bus and a separate data bus, and said common bus being formed by said data bus. Hence, as an example, the memory controller may also be used to control further memory devices such as SRAM devices or SDRAM devices, and hence in such embodiments a combined memory controller is provided for controlling multiple different types of memory devices.

Preferably, in such embodiments, the common bus is formed by the data bus. However, in alternative embodiments, provided that the address bus was implemented as a bi-directional bus, it will be appreciated that the common bus could in such instances be formed by the address bus if desired.

In such embodiments where the memory controller controls not only the memory device of the type described earlier, but also a further memory device of a different type, it will typically be the case that transfers to or from the further memory device are faster than transfers to or from the memory device. For example, transfers to or from SRAM or SDRAM devices are significantly faster than transfers to or from a NAND flash memory device. In such embodiments, the memory controller of preferred embodiments is preferably arranged such that in periods during a transfer to or from the memory device where the common bus is inactive, the control logic for controlling the further memory device is allowed to use the data bus to perform transfers to or from the further memory device. Hence, considering the example where the memory controller controls not only a NAND flash memory device, but also an SRAM or an SDRAM memory device, the memory controller of preferred embodiments allows SRAM or SDRAM accesses to be performed on the external bus while the NAND transfer is in an idle state, with the NAND transfer continuing once the access to SRAM or SDRAM has finished. This increases the efficiency of the external memory interface, as SRAM or SDRAM accesses are possible while the NAND flash is performing an internal operation that could otherwise lock up the external bus for up to a number of milliseconds.

Viewed from a second aspect, the present invention provides a method of controlling transfers to or from a memory device of a type where each transfer comprises a sequence of distinct phases and the actual sequence of distinct phases is dependent on the type of transfer, the method comprising the steps of: programming a number of programmable timing registers to store timing information appropriate for the memory device whose transfers are to be controlled; prior to each transfer, programming a number of programmable control registers to define the actual sequence of distinct phases to be performed for that transfer and one or more control values for that transfer; and generating each transfer dependent on the contents of the number of programmable timing registers and the number of programmable control registers.

### BRIEF DESCRIPTION OF THE DRAWINGS

The present invention will be described further, by way of example only, with reference to a preferred embodiment thereof as illustrated in the accompanying drawings, in which:

FIG. 1 is a block diagram illustrating a prior art memory controller for controlling a NAND flash memory device;

FIG. 2 is a flow diagram illustrating the process performed by the prior art device of FIG. 1;

FIG. 3 is a block diagram schematically illustrating a data processing system incorporating a memory controller in accordance with preferred embodiments of the present invention;

FIG. 4 is a block diagram illustrating a memory controller of preferred embodiments of the present invention used to control transfers to or from a NAND flash memory device;

FIG. 5 is a flow diagram illustrating the process performed to control transfers to or from a NAND flash memory device in accordance with preferred embodiments of the present invention;

FIG. 6 is a flow diagram illustrating the steps taken to program the control registers of the memory controller of preferred embodiments;

FIG. 7 is a block diagram illustrating the components of the NAND memory interface of the memory controller of preferred embodiments; and

FIGS. 8A and 8B are timing diagrams illustrating a read transfer and a write transfer in accordance with preferred embodiments of the present invention.

### DESCRIPTION OF A PREFERRED EMBODIMENT

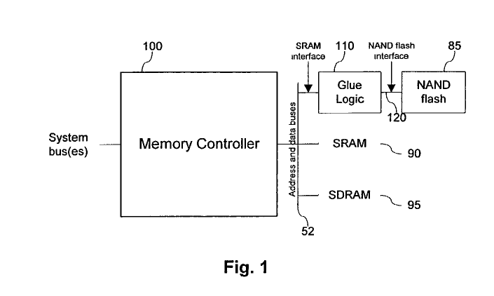

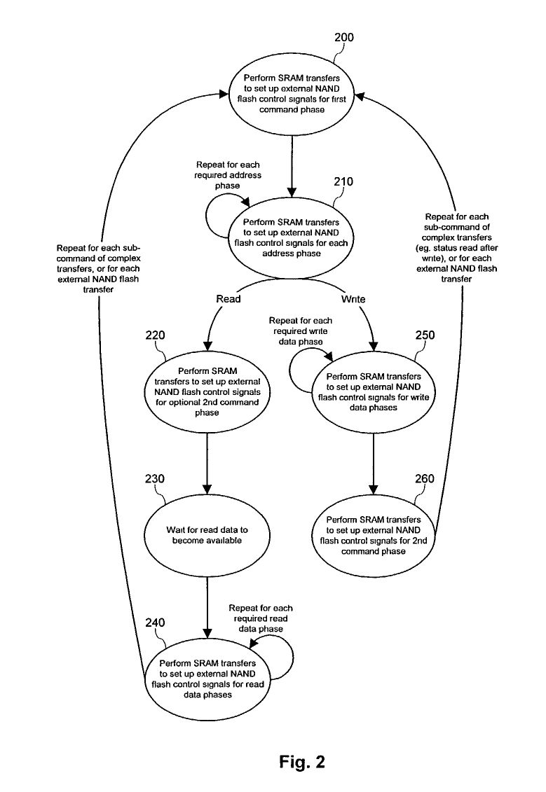

For the purposes of describing a preferred embodiment of the present invention, a memory controller for controlling a NAND flash memory device will be described. However, before describing the memory controller of preferred embodiments, a prior art interface device for a NAND flash memory device will first be described with reference to FIGS. 1 and 2. FIG. 1 is a block diagram of a prior art memory controller, this being described in the application note entitled “Simple System Interface for UltraNAND Flash”, Publication No. 22363, and available from AMD's website. This describes the implementation of an external NAND flash interface, namely glue logic 110 of FIG. 1, which is controlled using a standard memory controller 100, such as may be used to control SRAM or SDRAM. Hence, the memory controller 100 is connected in the usual manner to the system bus or buses, and is also coupled to separate address and data buses 52 to which can be connected SRAM 90 or SDRAM 95 in the usual manner. In addition, the glue logic 110 is coupled to the address and data buses 52 to receive signals output by the SRAM side of the memory controller 100 that are intended for the NAND flash memory device 85. Since NAND flash uses a combined address and data bus 120, whilst both SRAM and SDRAM use separate address and data buses, it is apparent that the signals output by the standard memory controller 100 cannot be passed directly to the NAND flash memory 85. Not only is the bus architecture different, but NAND flash memory devices also operate in a different way to SRAM or SDRAM devices, since NAND flash memory devices require a command value to be supplied over the single bus 120 to the NAND flash memory device during a command phase to define the type of transfer to be performed. This command phase is then followed by variable numbers of optional address phases, data phases, etc, dependent on the type of transfer to be performed.

FIG. 2 is a flow diagram illustrating the various communications performed between the memory controller 100 and the glue logic 110 in order to perform a transfer to or from the NAND flash memory device. At step 200, a series of SRAM transfers are performed between the memory controller 100 and the glue logic 110 in order to set up the external NAND flash control signals on the NAND flash interface bus 120 for the first command phase. The first distinct phase of any NAND flash transfer will be a command phase. The process then proceeds to step 210, where SRAM transfers are performed between the memory controller 100 and the glue logic 110 to set up on the NAND flash interface bus 120 the control signals for each address phase. Step 210 is then repeated for each required address phase.

Thereafter, the processing performed depends upon whether the transfer being performed is a read or a write transfer. In the event of a read transfer, the process branches to step 220, where SRAM transfers are again performed between the memory controller 100 and the glue logic 110 in order to set up external NAND flash control signals on the bus 120 in the event that an optional second command phase is required. Thereafter, the process proceeds to step 230, where the process waits for read data to become available at the output of the NAND flash device 85.

Thereafter, the process proceeds to step 240, where SRAM transfers are again performed between the memory controller 100 and the glue logic 110 in order to set up external NAND flash control signals on the bus 120 for each required read data phase, process 240 being repeated for each required read data phase. The process then returns to step 200 in order to be repeated for each sub-command of complex transfers, or for each external NAND flash transfer.

In the event of a write transfer, the process branches from step 210 to step 250, where SRAM transfers are performed between the memory controller 100 and the glue logic 110 to set up external NAND flash control signals on bus 120 for the write data phases. This is repeated for each required write phase. Thereafter, the process proceeds to step 260 where SRAM transfers are performed to set up external NAND flash control signals on the bus 120 for a second command phase that will typically be required for write transfers. Then the process returns to step 200 to allow the overall process to be repeated for each sub-command of complex transfers (for example status read after write), or for each external NAND flash transfer.

As is apparent from FIG. 2, the software required to generate the required control sequences with correct timing will be complex. Multiple memory accesses would need to be performed to generate the NAND flash transfer sequence, requiring extended use of the system bus to the memory controller via the system processor or other driving device. This in turn results in multiple transfers occurring across the external bus between the memory controller 100 and the glue logic 110 to cause the glue logic 110 to generate the correct control sequences with the correct timing, and this hence makes inefficient use of the external memory bus 52. As will be described in more detail with reference to the remaining figures, the memory controller of preferred embodiments of the present invention allows significantly improved efficiency over the basic hardware interface approach of the prior art of FIGS. 1 and 2.

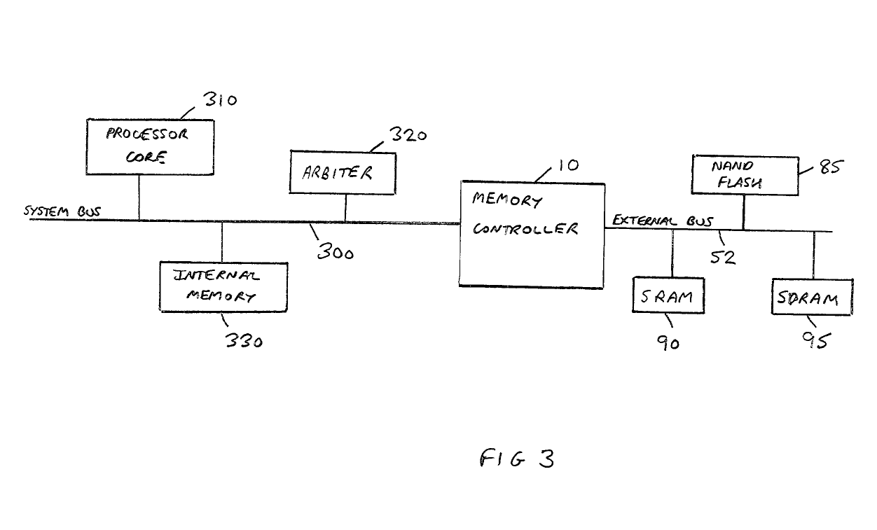

FIG. 3 is a block diagram schematically illustrating a data processing system in which the memory controller 10 of preferred embodiments may be employed. Memory controller 10 is coupled to a system bus 300 to which a number of logic units and other devices may be coupled. For the purposes of describing a preferred embodiment of the present invention, the only logic unit of interest is the processor core 310, which can be used to run appropriate software to program the memory controller 10 to enable NAND flash memory accesses to be performed. By way of illustration, FIG. 3 also shows an internal memory device 330 connected to the system bus 300, and an arbiter 320, which as will be appreciated by those skilled in the art is used to arbitrate between the various requests for access to the system bus by the logic units coupled to the system bus. For the sake of simplification, no further devices are illustrated in FIG. 3 as being coupled to the system bus, but it will be appreciated by those skilled in the art that there will typically be a number of logic units coupled to the system bus 300 that can request access to the system bus in addition to the processor core 310, for example a Direct Memory Access (DMA) controller, a coprocessor, a power management unit, etc., and the arbiter 320 is used to arbitrate between those various requests.

The system bus consists of a separate address and data bus in preferred embodiments of the present invention and indeed in certain embodiments the system bus may be replicated multiple times, for example 16 times, with a corresponding number of input ports being provided on the memory controller 10, thereby allowing multiple accesses to occur in parallel.

The memory controller 10 is also coupled to an external bus 52, which again has a separate address bus and a separate data bus. To this external bus 52 are coupled memory devices such as SRAM 90 and SDRAM 95 in the conventional manner. In accordance with preferred embodiments of the present invention, a NAND flash memory device 85 is also coupled to the external bus 52, but will receive all of its transfer signals over a single bus line, preferably the data bus.

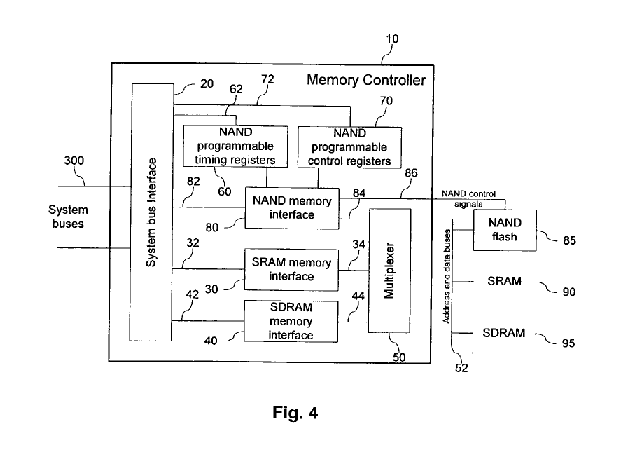

FIG. 4 illustrates in more detail the components provided within the memory controller 10 in accordance with preferred embodiments of the present invention. A system bus interface 20 is provided for interfacing with the system bus or system buses 300. For transfers to or from the SRAM 90 or the SDRAM 95, the signals are processed in the conventional manner, and accordingly are output from the system bus interface 20 via paths 32, 42 to the SRAM memory interface 30 or the SDRAM memory interface 40, respectively. From here, SRAM or SDRAM transfer signals are output over paths 34, 44, respectively to a multiplexer 50, from where they are output over the external bus 52 to the SRAM device 90 or the SDRAM device 95, respectively. The address signals will be passed over an address bus of the external bus 52, whilst the data signals will be passed over a data bus of the external bus 52. In addition, separate control signals will be routed to the SRAM device 90 or the SDRAM device 95 as appropriate, to identify the type of transfer taking place, and provide other required control signals to those memory devices (for simplicity these control signals are omitted from FIG. 4).

In order to control transfers to or from the NAND flash memory device 85, three logical components are provided within the memory controller 10, namely the NAND programmable timing registers 60, the NAND programmable control registers 70, and the NAND memory interface 80. Before any NAND flash transfers can be performed, the set of timing registers 60 must be configured, these being used to control the timing of the NAND flash control signals during the transfer. Hence, when a particular NAND flash device 85 is connected to the memory controller 10, some corresponding software will typically be run on the processor core 310 in order to program the relevant timing information into the timing registers 60 via the system bus interface 20 and the path 62. Although only a single NAND flash memory device 85 is illustrated in FIG. 4, it is possible that the memory controller 10 can be used to control multiple NAND flash memory devices 85. In that scenario, the timing registers 60 will apply to all NAND devices connected to the memory controller, and so the slowest timing values must be programmed into the timing registers 60 to ensure that all NAND devices coupled to the memory controller 10 will be accessed correctly. However, if the NAND devices have very different timing requirements, then it will be appreciated that the timing registers could be re-programmed between accesses to different NAND devices.

However, considering the scenario where a single NAND flash memory device 85 is coupled to the memory controller 10, it will be appreciated that the NAND programmable timing registers 60 would typically be programmed once at set up time, and thereafter would not be reprogrammed unless an additional NAND flash memory device were to be connected. The memory controller 10 then retains internally all of the necessary timing information to enable it to generate NAND flash transfer sequences with the correct timing.

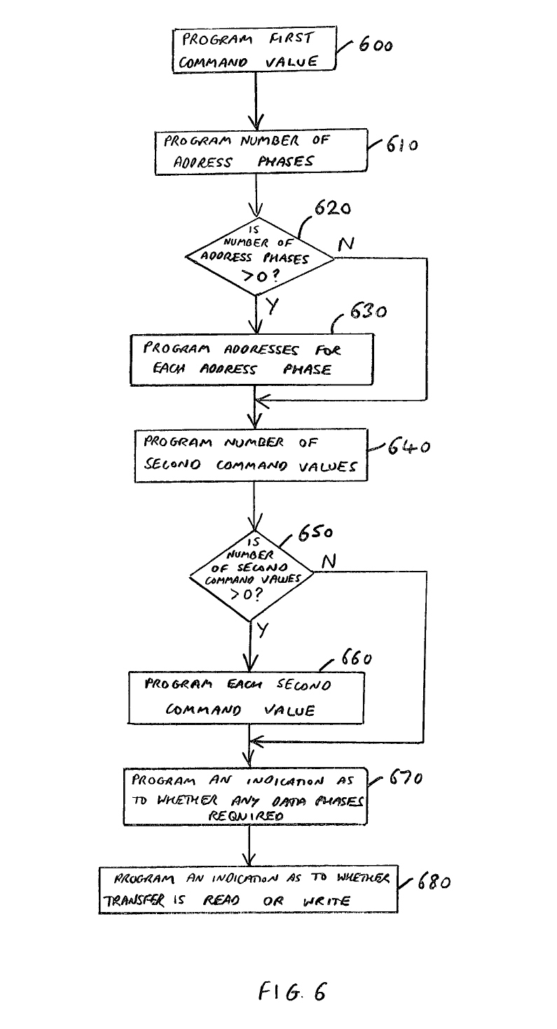

The NAND programmable control registers 70 are used, for each transfer, to define the actual sequence of distinct phases to be performed for that transfer, and one or more control values for that transfer. Again, the programming of these registers will typically be performed by appropriate software executing on the processor core 310. The programming of these control registers 70 by such software will now be discussed with reference to FIG. 6.

FIG. 6 is a flow diagram illustrating conceptually the routine performed by the software to program the control registers 70 with the required information for each transfer. At step 600, a first command value to be used for the initial command phase is programmed. In preferred embodiments, there will always be a single initial command phase. It will be appreciated that in some embodiments there could be multiple initial command phases, in which event step 600 would be altered to include a step of identifying the number of initial command phases/values and to program each initial command value.

Thereafter, the process proceeds to step 610, where the number of address phases is programmed. As discussed earlier, the address phases are optional, and will depend on the type of transfer being performed. In addition, different numbers of address phases will be required by different types of transfer.

Hence, the process then proceeds to step 620, where it is determined whether the number of address phases is greater than zero. If it is, then the actual addresses for those address phases are programmed at step 630. Thereafter, the process proceeds to step 640, or proceeds directly to step 640 from step 620 if no address phases are present. At step 640, the number of second command values associated with one or more second command phases are programmed. As with the address phases, second command phases are optional, and will depend on the type of transfer. In preferred embodiments of the present invention, to the extent that there are any second command phases, there will typically only be a single second command phase, but it is possible that NAND flash transfers could be defined which require more than one second command phase.

Hence, at step 650, it is determined whether the number of second command values is greater than zero, and if it is the process proceeds to step 660, where each second command value is programmed. Thereafter, the process proceeds to step 670, or proceeds directly to step 670 from step 650 in the event that there are no second command values.

At step 670, an indication as to whether any data phases are required by the transfer is programmed, and thereafter at step 680 an indication as to whether the transfer is a read or a write transfer is programmed.

Although in FIG. 6 the steps are shown sequentially to illustrate the pieces of information that need to be constructed by the software for storing in the control registers 70, in preferred embodiments the actual programming of these values into the control registers is not performed sequentially as shown in FIG. 6. For example, all of the command values are preferably stored within a single register, and accordingly steps 600 and 660 would be performed at the same time by sending the command values as a single data block for storing in a particular control register 70. Similarly, the number of address phases, the number of second command values, the indication as to whether any data phases are required, and the indication as to whether the transfer is a read or a write transfer are all preferably stored within a single control register in the set of control registers 70, and so steps 610, 640, 670 and 680 will typically be performed together by sending a single data block of information to the relevant control register. Further, with regard to the step 630, in preferred embodiments each address is 8 bits in length, whereas each control register is 32 bits in length. Accordingly, up to four addresses may be output at a time over the system bus 300 for storing in a single control register. In preferred embodiments, it is typically the case that three or four register write processes need to be performed to the programmable control registers 70 in order to define all of the required sequencing and control value information required for a particular transfer.

The following table illustrates the number of bits required for each of the above mentioned programmable values in preferred embodiments of the present invention.

TABLE 1

| Programmable Value | Bits Required |
|---|---|
| First command vector | 8 |
| Second command vector | 8 |
| Number of address phases required (0-7) | 3 |
| Data phase required | 1 |
| Second command phase required | 1 |
| Transfer type - read/write | 1 |
| Address vector (each one) | 8 |

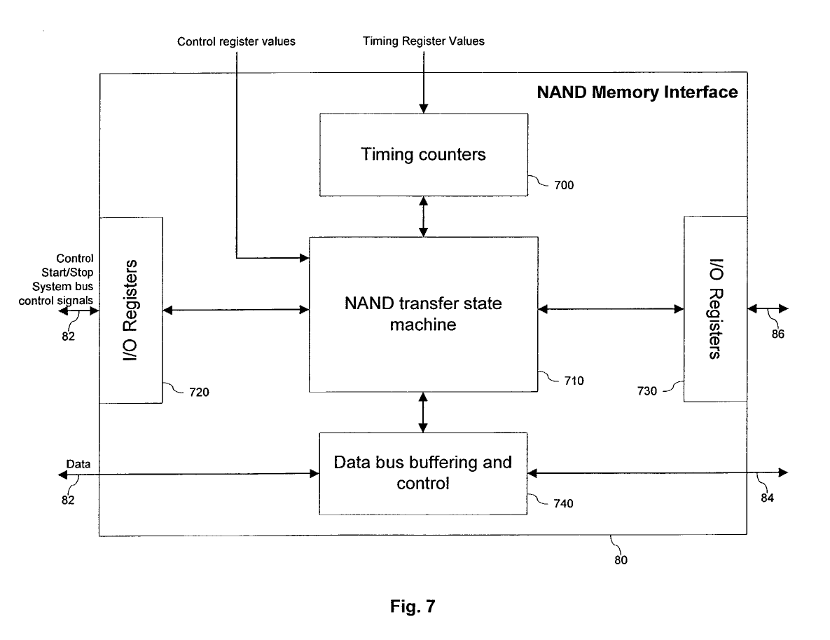

Once the control registers have been programmed for a particular transfer, the NAND memory interface 80 is then able to generate the required transfer having regard to the contents of the timing registers 60 and the control registers 70. With reference to FIG. 7, the values in timing registers 60 are loaded into timing counters 700 within the NAND memory interface 80 when required. In preferred embodiments, there are not separate counters for each of the programmable timing values, as they are never all needed at the same time. Hence, in preferred embodiments, the counters 700 are shared counters which are loaded with the required timing value when needed, according to the current phase of the transfer being performed. By this approach, the gatecount can be reduced.

Once the control registers have been programmed, a single system bus transfer will typically be issued to the system bus interface 20 for passing over path 82 to the input/output register 720 of the NAND memory interface 80, which is then passed on to the NAND transfer state machine 710 to indicate that the external NAND flash memory access should be initiated. The state machine 710 will then retrieve the values from control registers 70 and begin constructing the transfer. The command phase, followed by the optional address, data and second command phases, are constructed from the contents of the control registers 70 and output via the data bus buffering and control logic 740 to the multiplexer 50 over path 84. Further, all the required timing signals for the NAND flash transfer are generated by the state machine 710 having regard to the contents of the timing counters 700, with these signals being output to the input/output registers 730 for output over path 86 to the NAND flash memory device 85. It will be appreciated by those skilled in the art that the timing values are also used for values output on the data bus, and so timing is applied to outputs on both paths 84 and 86.

Once the NAND transfer has been set up as described above, each system bus read or write will cause a NAND data transfer. Hence, in the event of a read access, when the read data becomes available from the NAND flash memory device, each system bus read will cause data to be routed back via the multiplexer 50 and over path 84 into the data bus buffering and control logic 740, from where it can be output over path 82 to the system bus interface 20 for outputting on the system bus 300. Similarly, in the event of a write access, each system bus write will cause the necessary write data to be output from the processor, and then routed from the system bus interface over path 82 to the data bus buffering and control logic 740, from where it can be output over path 84 to the multiplexer 50 as required for passing on to the NAND flash memory device 85.

For either a read or a write transfer, logic 740 will perform any size conversion required, so that if, for example, a 32-bit transfer to 8-bit memory is performed, four external NAND data transfers will be performed.

Once the necessary number of reads or writes has been performed, one further single system bus transfer is required to terminate the transfer. This takes the form of a stop command issued to end the NAND transfer. For a read transfer, the read operation will end immediately, whilst for a write transfer a second command phase will first be performed.

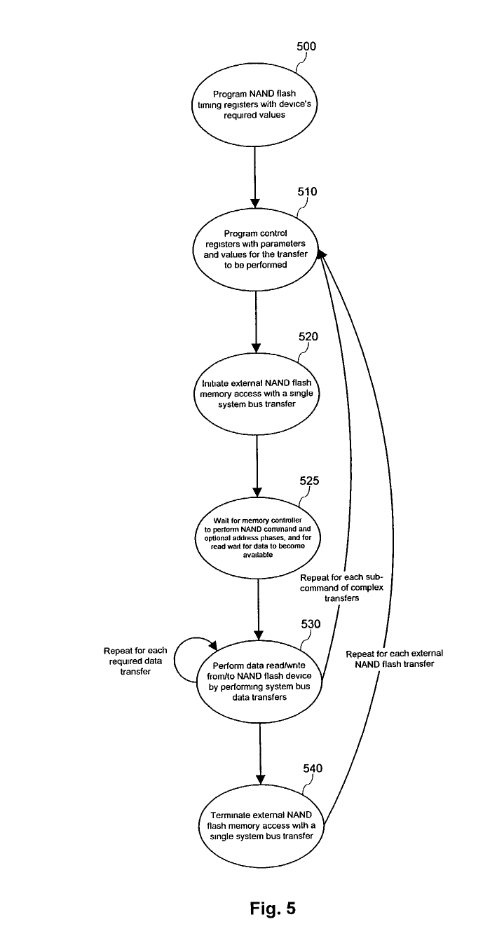

FIG. 5 is a flow diagram which summarises the process performed to generate NAND flash transfers in accordance with preferred embodiments of the present invention as described above. At step 500, the NAND flash timing register 60 are programmed with the device's required timing values, preferably by appropriate software running on the processor core 310. As mentioned earlier, this process would typically be performed once at set up time. The timing information that would typically be stored would include information such as set up times for signals, duration of asserted signals, hold times, etc.

The process then proceeds to step 510, where the control registers 70 are programmed with the parameters and values required for the transfer to be performed. This process has already been discussed earlier with reference to FIG. 6. Thereafter, the process proceeds to step 520, where a single system bus transfer occurs to initiate the external NAND flash memory access. As mentioned earlier, this signal is routed to the NAND memory interface 80 to cause the NAND memory interface to begin to generate the NAND flash memory access. Thereafter the process proceeds to step 525, where the process waits for the memory controller to perform the NAND command and optional address phases, and in the event of a read waits for the read data to become available. While this process is being performed, the system bus is idle, and no further control signals need to be issued, the memory controller 10 internally having all of the required information to enable the command and variable number of address and second command phases to be generated. Thereafter, the process proceeds to step 530, where the necessary data read or write transfers are performed from or to the NAND flash device by performing appropriate system bus data transfers, step 530 being repeated for each required data transfer. The process then returns to step 510 to enable steps 510, 520 and 530 to be repeated for each sub-command of complex transfers.

Thereafter, the process proceeds to step 540 where the external NAND flash memory access is terminated with a single system bus transfer, this signal being routed via the system bus interface over path 82 to the NAND memory interface 80 to terminate the NAND flash memory access, performing the second command phase for a write transfer. The process then returns to step 510 to enable it to be repeated for each subsequent external NAND flash memory transfer.

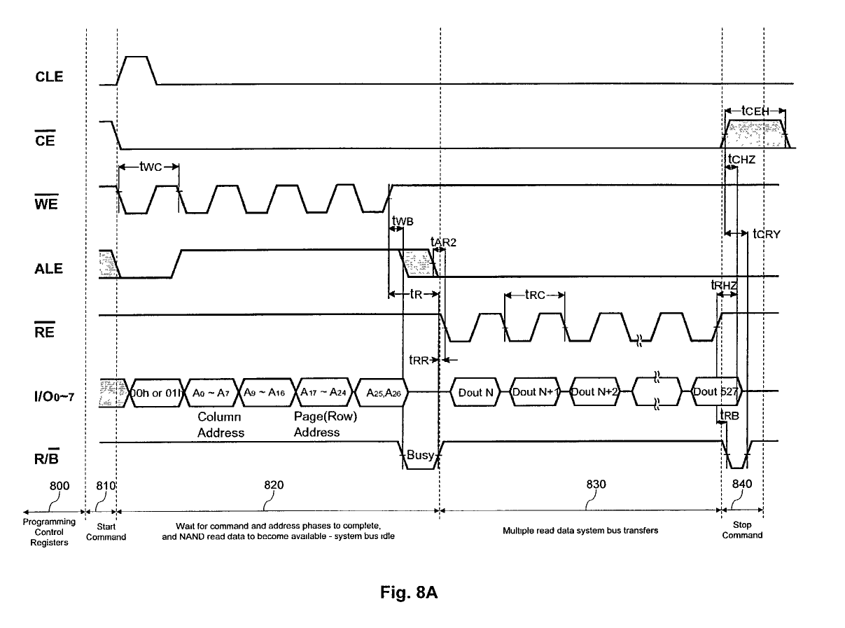

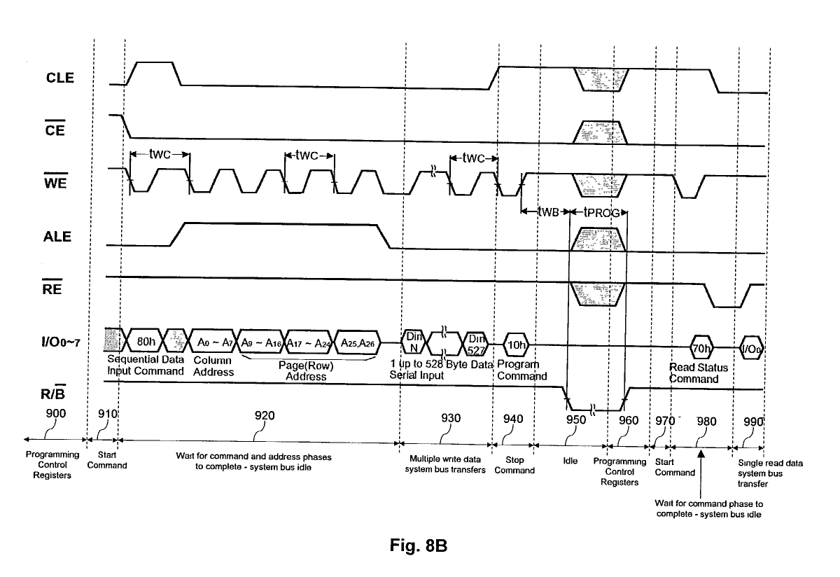

FIGS. 8A and 8B are timing diagrams illustrating the format of the NAND flash memory transfers for a read access and a write access, respectively. Looking first at FIG. 8A, the signals CLE, CE, WE, ALE, RE and R/B are control signals that will be issued by the state machine 710 to the input/output register 730 for outputting over path 86 to the NAND flash memory device. As will be appreciated by those skilled in the art, these are standard signals required by NAND flash memory devices, CLE being a command latch enable signal, CE being a chip enable signal, WE being a write enable signal, ALE being an address latch enable signal, RE being a read enable signal and R/B being a ready/busy indication signal.

The 1/0 signal indicates the signal produced on the input/output common command/address/data bus (formed in preferred embodiments by the data bus of the external bus 52). As can be seen from the lower portion of FIG. 8A, during time interval 800, the control registers 70 are being programmed, i.e. step 510 of FIG. 5 is being performed. Thereafter, during interval 810, the start command is issued (i.e. step 520 of FIG. 5 is being performed). Thereafter, during time interval 820, the system bus is idle waiting for the NAND read data to become available, i.e. step 525 of FIG. 5 is being performed. Then during interval 830, multiple system bus transfers are performed to read the data, i.e. step 530 of FIG. 5 is performed. Finally, during interval 840, a stop command is issued to terminate the NAND flash memory access, i.e. step 540 is performed.

As can be seen from FIG. 8A, the particular example of the read access shown in FIG. 8A involves the generation of a command phase followed by four address phases, after which a plurality of separate data values are read.

Looking now at FIG. 8B, the 1/0 signals shows the signals issued on the common command/address/data bus, this consisting of a command phase, followed by four address phases, followed by the writing of multiple data values, followed by a second command phase during which the stop command is generated. In this particular example, a subsequent transfer is also performed in order to perform a read status check, i.e. to check that the written data has been written correctly.

Accordingly, at step 900, the control registers are programmed, whereafter the start command is issued during interval 910, and then during interval 920 the system bus becomes idle waiting for the command and address phases to complete. Thereafter, during interval 930, the write data is produced by appropriate system bus transfers (see step 530 of FIG. 5) whereafter during interval 940 the stop command is issued (see step 540 of FIG. 5). During interval 950 (where the temporarily stored data is written to memory), the system bus then enters an idle state between transfers, whereafter during interval 960 the control registers are programmed for the read status transfer. Then during interval 970, the start command is issued (see step 520 of FIG. 5) and is followed during interval 980 by a period in which the system bus is idle waiting for the command phase to complete. Thereafter, during interval 990, a system bus transfer is performed to read the data (see step 530 of FIG. 5).

It will be appreciated that the “write followed by read status” process could be performed as two totally separate transfers as shown in FIG. 8B, or alternatively the status read could form the second part of the whole transfer, thereby using the path between steps 530 and 510 in FIG. 5, rather than the path between steps 540 and 510.

For completeness, a further description of the control of NAND flash transfers in accordance with one particular embodiment of the present invention will now be provided:

NAND Flash Memory Controller Initialisation

Before any NAND flash transfers are performed, a set of NAND flash specific timing registers must be configured, which are used to control the timing of the NAND flash control signals during the transfer. The default values for all of the NAND timing registers are the maximum possible, but the majority of devices will be able to operate with faster timing. The NAND timing registers apply to all NAND devices in the system, so the slowest timing values must be programmed to ensure that all devices in the system will be accessed correctly. If the devices have very different timing requirements, then the NAND timing registers may be re-programmed between accesses to different devices.

Before each external NAND flash transfer is performed, the NAND control and address registers must be set up for the transfer.

The NAND control register is used to define the sequence of phases that are performed during the transfer. There is always a command phase at the start of the transfer to indicate to the memory what type of transfer is being performed, which is then followed by a combination of the optional address, data and second command phases depending on the transfer type and device being accessed.

For example, a simple data read transfer is one command phase, three address phases, a busy phase where the data is moved internally from the memory to the NAND flash device's output data registers, then a number of data phases depending on the amount of data being read.

The command bits of the NAND control register are used to store the two 8-bit command vectors. The first vector value must always be programmed, but the second value is only used if the bit is set which indicates whether a second command phase is performed during the transfer.

There is only one set of NAND control and address registers used to drive all connected NAND flash devices, so two bits are used to select which chip select will be used for the programmed transfer. This ensures that the transfer is only performed to the correct device.

The address phase bits define whether there is an address phase, and how many address vectors are performed during the address phase. The maximum number of address vectors allowed is 5. Each section of the NAND address value registers should be programmed with the address vectors required for the transfer. Unused address vectors do not need their values changing.

The data phase bit defines whether a data phase is performed. The number of data transfers is not defined, as system bus read/write transfers will be converted into external read/write transfers.

The ID read bit is used to indicate that the current transfer is an ID read. This is needed due to the special timing requirements of ID read transfers, which are performed differently to standard data reads.

The short read bit is used to indicate that a read transfer does not need to check the status of the ready/busy output before performing the data phase of the transfer. The programmed CLE to RE delay value is used to control the timing of the read transfer.

The read/write bit is used to indicate the type of transfer being performed, either a read or a write. A transfer that performs a data read must be programmed as a read. A transfer that performs a data write or has no data phase (e.g. block erase) must be programmed as a write.

Once the NAND control and address registers have been programmed with the relevant values, the NAND flash transfer may be performed.

NAND Flash Transfer Control

NAND flash transfers are controlled with read or write transfers to the chip select programmed into the chip select bits of the NAND control register. An access to a different chip select will not perform a NAND access. The lower bits of the address used for the NAND transfer controls the operation performed, as shown in the table below.

TABLE 2
NAND flash transfer addresses

| | System Bus | |
|---|---|---|
| Transfer | Address[11:0] | Description |
| Start | 0×000 | Initiate transfer, or start new command |
| | | and address phase |
| Command-2 | 0×008 | Perform a second command phase after a |
| | | write data phase without ending the |
| | | transfer |
| Stop | 0×010 | Ends the current transfer, performing |
| | | a second command phase if required |
| Read/Write | 0×011 and | Read or write data transfers |
| | higher | |

The address value used for the transfer is unrelated to the NAND device address, as this has already been programmed into the NAND address value registers. Once granted access to the external bus, the internal control state machine then drives the control signals to generate the NAND flash transfer. Read and write data is buffered in both directions depending on the sizes of the AHB (system bus) transfers and the NAND flash devices used, as for normal SRAM transfers.

Transfers to the Start, Command-2 and Stop addresses may be performed using either system bus reads or writes. A read will return undefined data which must be discarded. The data value of a write transfer will not be used by the memory controller.

The Start address is used to initiate the external NAND transfer. The programmed control and address phases will be performed up to (but not including) the first data phase. The value of the read/write bit is used to determine if the transfer is a read or a write.

Note A NAND transfer with no data phase must be initiated with a single system bus write of any value to the required chip select's Start address. Initiating a transfer with no data phase using a system bus read may result in unpredictable behaviour.

Performing a second access to the Start address allows NAND transfers that require multiple sets of control and address phases to be performed, for example a copy-back program. These transfers are described in more detail later in this section.

The Command-2 address is used to insert a second command phase at the end of a write data phase when the transfer will not be ended, and further control/address phases will be performed, for example, during a cache program transfer. This command has no effect during a read transfer (as the second command phase is performed before the data phase), and will only be performed during a write transfer if the second command bit of the NAND control register is set.

The Stop address is used to end the current transfer, and must be performed when the NAND interface busy bit of the NAND status register is sampled low, indicating that the transfer is idle and can be safely ended. The data value for the transfer will not be used, so the data phase must have been completed before performing a Stop access. During a write transfer, a second command phase will be performed if the second command bit of the NAND control register is set.

Normal data phase read and write transfers are performed to an address which is 0×011 or greater. This allows reads and writes to be performed to static, random or incrementing addresses. During a NAND read transfer, only system bus reads may be performed. During a NAND write transfer, both system bus reads and writes may be performed, allowing a status read to be performed without deasserting the chip select to perform a separate read transfer.

Some NAND transfers require multiple command and address phases to be performed while the chip select is held asserted. This is possible through accessing the Start address each time a new set of command and address phases is to be performed, but the NAND control and address registers must be updated with new values for the subsequent phases. The NAND interface busy bit of the NAND status register is used to determine when it is safe to write new values to the NAND control and address registers. When this bit is sampled high, it indicates that the NAND interface is busy and the registers can not be updated as they could be in use. Once this bit is sampled low, new values may be written to the NAND control and address registers.

Note

Any sequence of write transfers is permitted to 8-bit NAND flash devices, but byte writes to 16-bit NAND flash devices must always be performed in bursts of even numbers of transfers. If an odd number of bytes are written to a 16-bit NAND flash device, the upper byte of the last external data write transfer will be of an unknown value, and software must ensure that the halfword at that address is overwritten with the correct data.

Note

Sequential row read transfers insert a busy phase between rows. This must be checked by software using the NAND flash status register, as the hardware is unable to detect when the last read of a row is performed.

NAND Flash Transfer Types

The exact ordering of the NAND flash transfer depends on the type of system bus transfer used to initiate it and the settings in the NAND control register:

a transfer with no address phase is assumed to be a status read, which does not use the ready output to control the timing of the data phase, so the CLE to RE delay is used

a read transfer with a second command phase and data phase will perform the second command phase before the data phase

a write transfer with a second command phase and data phase will perform the second command phase after the data phase

all reads other than status and ID reads will wait for the ready output to be deasserted and asserted before reading back any data if the short read bit of the NAND control register is cleared

all writes that have received a Stop address will wait for the ready output to be deasserted after all data and command phases before ending the transfer and deasserting the chip select to the device.

Accessing Other Memory During NAND Flash Transfers

Due to the long access times of NAND devices when compared to SRAM and SDRAM devices, the memory interface allows accesses to other memory devices to be performed during idle times in a NAND transfer. For example, this allows instruction or data fetches to be performed during a long page read/write operation to the NAND device, or other system activity to take place during a long page program operation.

Note

Only one NAND device may be accessed at a time.

Once the NAND interface busy bit of the NAND status register indicates the interface is idle, the internal memory controller arbitration will allow SRAM or SDRAM accesses to be performed if any are pending. The normal arbitration scheme will apply, and the NAND access may continue once the system bus port performing the NAND access is granted control of the external memory. The NAND control signals and the device's chip select will be held stable throughout the accesses to other memory devices. The NAND transfer status bit of the NAND status register indicates that a NAND transfer is still in progress.

Note

Only a single system bus master may access the NAND device at a time. Check the status bits to determine when the NAND interface is idle. Simultaneous NAND accesses by multiple system bus masters may result in unpredictable behaviour.

NAND Flash Transfer Error Responses

The following transfers will generate system bus error responses:

An access to a chip select set as NAND flash in the static memory configuration register, but which is not programmed into the chip select bits of the NAND control register. This indicates that the NAND control register has not been correctly configured to perform an access to the current chip select.

A write to the NAND control or address registers when the NAND interface busy status register bit is HIGH, indicating that the NAND interface is busy so the NAND control and address registers may be in use and cannot be modified. The status of the NAND interface busy bit must be checked before writing to the NAND control or address registers.

A write to the NAND timing registers when the NAND transfer status bit is HIGH, indicating that a NAND transfer is currently in progress, so the timing parameters are in use. The status of the NAND transfer status bit must be checked before writing to the NAND timing registers.

NAND Flash Performance Implications

The timing of NAND flash devices is generally much slower than SRAM and SDRAM. This means that NAND flash transfers will use the external bus for a relatively long period of time, especially during the device's busy periods for a read, program or erase operation which range from microseconds to milliseconds.

The NAND flash interface has been designed to allow SRAM and SDRAM accesses to be performed during the idle periods in a NAND flash transfer, but there may still be large delays while the command and address phases of a NAND access are being performed. SDRAM refreshes are not affected by NAND flash accesses, and will always be performed when required.

The system designer must be aware of the implications of NAND flash accesses in systems that also contain high speed SRAM or SDRAM, and devices that make regular use of the external bus for data transfers.

From the above description, it will be appreciated that the memory controller of preferred embodiments of the present invention has sufficient hardware built in to enable the necessary sequence of transfers required to perform a NAND flash access to be readily generated, without needing any hard-coded information on the control values or device properties. Software is used to program the interface for the required transfer sequence, along with the device's timing requirements, and to supply the device dependent access control values. A simple read or write to the memory controller is then all that is needed to initiate the external transfer, with the hardware within the memory controller automatically performing the programmed command and address phases before the first data transfer. This balance between hardware and software control of the NAND flash interface allows for efficient transfers to be performed, with lower use of the system bus than required by an external interface, and furthermore support for future NAND flash devices will typically only require updates to the software that controls the hardware.

In a preferred embodiment of the present invention, since the access speeds of NAND devices are slow when compared to SRAM and SDRAM devices, the interface has been implemented to allow SRAM and SDRAM accesses to be performed on the external bus while the NAND transfer is in an idle state, with the NAND transfer continuing once the access to other memory has finished. This increases the efficiency of the external memory interface, as SRAM or SDRAM accesses are possible while the NAND flash is performing an internal operation that could otherwise lock up the external bus for up to a number of milliseconds. For example, in one particular implementation, the read busy time (tR—see FIG. 8A) is around 10 microseconds, the write program time (tPROG—see FIG. 8B) is around 200 to 1000 microseconds, and the erase time (for a block erase command, not shown in FIGS. 8A and 8B) is 2 to 10 milliseconds. There will also be other delays, for example the time it takes for status read data to be available, which may for example be of the order of 50 nanoseconds.

In summary, the hardware provided within the memory controller in preferred embodiments to control transfers to and from the NAND flash memory device consists of a state machine and external pins to control the NAND flash device, a bank of timing registers used to control the timing of the NAND flash control signals, and a bank of control registers used to store the command and address values and transfer sequence required. Software is then used to configure the timing registers once during system initialisation, to configure the control registers for each NAND flash access, and then to perform the data write or read transfers to or from the memory controller.

It will be appreciated that the memory controller could be embodied as a stand-alone NAND flash memory controller (i.e. without the SRAM memory interface and SDRAM memory interface), or could as shown in the figures be incorporated within a memory controller that also provides support for devices such as SRAM and SDRAM.

It should be noted that the NAND flash interface presented by the memory controller of preferred embodiments is independent of the processor architecture or system bus in use, and could be applied to any system where a memory controller block is used as the interface between a device and some NAND flash memory.

Although a particular embodiment has been described herein, it will be apparent that the invention is not limited thereto, and that many modifications and additions thereto may be made within the scope of the invention. For example, various combinations of the features of the following dependent claims can be made with the features of the independent claims without departing from the scope of the present invention.

I claim

1. A memory controller for controlling transfers to or from a memory device of a type where each transfer comprises a sequence of distinct phases and the actual sequence of distinct phases is dependent on the type of transfer, the memory controller comprising:
a memory device interface operable to couple the memory controller with the memory device;
a number of programmable timing registers programmable to store timing information appropriate for the memory device whose transfers are to be controlled by the memory controller;
a number of programmable control registers which, prior to each transfer, are programmable to define the actual sequence of distinct phases to be performed for that transfer and one or more control values for that transfer; and
a sequence generator operable to generate each transfer dependent on the contents of the number of programmable timing registers and the number of programmable control registers, and to output each transfer via the memory device interface.

2. A memory controller as claimed in claim 1, wherein the memory device is arranged to receive said distinct phases of each transfer over a common bus coupled to said memory device interface.

3. A memory controller as claimed in claim 1, wherein the memory device is a NAND flash memory device.

4. A memory controller as claimed in claim 1, wherein a first distinct phase is a command phase during which information identifying the type of transfer is provided to the memory device.

5. A memory controller as claimed in claim 4, wherein said one or more control values programmable into said number of programmable control registers comprise one or more command values associated with the command phase of said transfer.

6. A memory controller as claimed in claim 1, wherein a second distinct phase is an optional address phase during which an address associated with the transfer is provided.

7. A memory controller as claimed in claim 6, wherein said one or more control values programmable into said number of programmable control registers comprise any addresses associated with the transfer.

8. A memory controller as claimed in claim 1, wherein a third distinct phase is an optional data phase in which a data value is written to or read from the memory device.

9. A memory controller as claimed in claim 1, further comprising a system bus interface operable to couple the memory controller with a system bus over which may be provided control signals used to program said number of programmable timing registers and said number of programmable control registers.

10. A memory controller as claimed in claim 9, wherein a processor is coupled to said system bus and is operable to execute software in order to generate said control signals.

11. A memory controller as claimed in claim 1, wherein said sequence generator comprises a state machine operable to generate for each transfer the corresponding sequence of distinct phases.

12. A memory controller as claimed in claim 1, wherein the memory controller is operable to control transfers to or from a plurality of said memory devices of the type where each transfer comprises a sequence of distinct phases and the actual sequence of distinct phases is dependent on the type of transfer.

13. A memory controller as claimed in claim 2, wherein the memory controller further comprises control logic operable to control a further memory device of a different type, the further memory device being arranged to communicate with the memory controller via an address bus and a separate data bus, and said common bus being formed by said data bus.

14. A memory controller as claimed in claim 13, wherein transfers to or from said further memory device are faster than transfers to or from said memory device, and in periods during a transfer to or from said memory device where the common bus is inactive, the control logic for controlling the further memory device is allowed to use the data bus to perform transfers to or from the further memory device.

15. A method of controlling transfers to or from a memory device of a type where each transfer comprises a sequence of distinct phases and the actual sequence of distinct phases is dependent on the type of transfer, the method comprising the steps of:
programming a number of programmable timing registers to store timing information appropriate for the memory device whose transfers are to be controlled;
prior to each transfer, programming a number of programmable control registers to define the actual sequence of distinct phases to be performed for that transfer and one or more control values for that transfer; and
generating each transfer dependent on the contents of the number of programmable timing registers and the number of programmable control registers.

16. A method as claimed in claim 15, wherein the memory device is arranged to receive said distinct phases of each transfer over a common bus.

17. A method as claimed in claim 15, wherein the memory device is a NAND flash memory device.

18. A method as claimed in claim 15, wherein a first distinct phase is a command phase during which information identifying the type of transfer is provided to the memory device.

19. A method as claimed in claim 18, wherein said one or more control values programmable into said number of programmable control registers comprise one or more command values associated with the command phase of said transfer.

20. A method as claimed in claim 15, wherein a second distinct phase is an optional address phase during which an address associated with the transfer is provided.

21. A method as claimed in claim 20, wherein said one or more control values programmable into said number of programmable control registers comprise any addresses associated with the transfer.

22. A method as claimed in claim 15, wherein a third distinct phase is an optional data phase in which a data value is written to or read from the memory device.

23. A method as claimed in claim 15, further comprising the steps of:
providing over a system bus control signals used to program said number of programmable timing registers and said number of programmable control registers.

24. A method as claimed in claim 23, wherein a processor is coupled to said system bus and is operable to execute software in order to generate said control signals.

25. A method as claimed in claim 15, wherein said step of generating each transfer comprises the step of employing a state machine to generate for each transfer the corresponding sequence of distinct phases.

26. A method as claimed in claim 15, further comprising the step of controlling transfers to or from a plurality of said memory devices of the type where each transfer comprises a sequence of distinct phases and the actual sequence of distinct phases is dependent on the type of transfer.

27. A method as claimed in claim 16, further comprising the step of controlling a further memory device of a different type, communication with the further memory device occurring via an address bus and a separate data bus, and said common bus being formed by said data bus.

28. A method as claimed in claim 27, wherein transfers to or from said further memory device are faster than transfers to or from said memory device, and in periods during a transfer to or from said memory device where the common bus is inactive, the method further comprises the step of allowing the data bus to be used to perform transfers to or from the further memory device.

29. A memory controller for controlling transfers to or from a NAND flash memory device, each transfer comprising a sequence of distinct phases, the memory controller comprising:
a memory device interface operable to couple the memory controller with the NAND flash memory device;
a number of programmable timing registers programmable to store timing information appropriate for the NAND flash memory device whose transfers are to be controlled by the memory controller;
a number of programmable control registers which, prior to each transfer, are programmable to define the actual sequence of distinct phases to be performed for that transfer and one or more control values for that transfer; and
a sequence generator operable to generate each transfer dependent on the contents of the number of programmable timing registers and the number of programmable control registers, and to output each transfer via the memory device interface.
